(19) United States
(12) Patent Application Publication
(10) Pub. No.: US 2026/0031071 A1
(43) Pub. Date: Jan. 29, 2026

(54) GENERATING MULTI-TRACK MUSIC FROM TEXT PROMPTS WITH DIFFUSION MODELS

(71) Applicant: Futureverse Corporation Limited, Auckland (NZ)

(72) Inventors: Yijun Wang, Auckland (NZ); Yao Yao, Shenzhen (CN); Boyu Chen, Sydney (AU)

(21) Appl. No.: 19/182,474

(22) Filed: Apr. 17, 2025

Related U.S. Application Data
(60) Provisional application No. 63/674,952, filed on Jul. 24, 2024.

(51) Int. Cl. G10H 1/00

(52) U.S. Cl. CPC G10H 1/0025; G10H 2210/066; G10H 2210/111; G10H 2220/116

(57) ABSTRACT

Methods, systems, and devices for multi-track music generation are described. In some examples, a method includes receiving a text prompt describing desired musical attributes and generating, using a diffusion model, multiple audio tracks based on the text prompt, wherein each audio track corresponds to a different musical component. The method can further include assigning individual timestep vectors respectively to each of multiple audio tracks and generating, using a diffusion model, one or more enhanced audio tracks based on the individual timestep vectors and corresponding audio track. Finally, the method can include combining the generated audio tracks to produce a multi-track musical composition.

### CROSS REFERENCE TO RELATED APPLICATIONS

The present Application for Patent claims the benefit of U.S. Provisional Application Ser. No. 63/674,952 filed on Jul. 24, 2024, the disclosure of which is hereby incorporated by reference in its entirety.

### FIELD OF TECHNOLOGY

The present disclosure relates generally to generative Artificial Intelligence (AI), and more specifically to generating multi-track music with diffusion models.

### BACKGROUND

The field of music generation has seen significant advancements with the advent of artificial intelligence and machine learning technologies. Early systems utilized symbolic representations to translate textual descriptions into MIDI-style outputs. These methods often relied on predefined virtual synthesizers, which can limit audio quality and diversity. Recent models have advanced the field by generating authentic audio waveforms directly from text prompts. These models typically produce composite audio mixes rather than discrete, manipulable tracks, which can restrict the level of creative control necessary for professional music production. There is a growing interest in developing more sophisticated models that can generate and integrate individual tracks in a controllable manner, providing greater flexibility and control in multi-track music generation.

### SUMMARY

The disclosed implementations relate to improved methods, systems, devices, and apparatuses that support techniques for generating multi-track music from text prompts with diffusion models. Some implementations can address these challenges by introducing an advanced framework that utilizes an audio latent diffusion model to generate multiple audio tracks based on text prompts. Each audio track can correspond to a different musical component, such as bass, drums, instruments, and melody. The model can incorporate individual timestep vectors for each track, allowing for precise control over the generation process. This approach can ensure that each track can be generated and refined independently while maintaining temporal and harmonic coherence with other tracks.

To further enhance the multi-track generation capabilities, some implementations can employ a progressive curriculum training strategy. This strategy can gradually increase the complexity of the generation tasks, enabling the model to learn and adapt to more intricate multi-track compositions over time. By progressively introducing more complex tasks, the model can develop the ability to generate high-fidelity, harmoniously aligned multi-track music. This innovative approach can not only simplify the creative process for users but also ensure that the generated music meets professional standards of quality and coherence.

A method for multi-track music generation is described. The method can include receiving a text prompt describing desired musical attributes. The method can include generating, using a diffusion model, multiple audio tracks based on the text prompt, wherein each audio track can correspond to a different musical component. The method can include assigning individual timestep vectors respectively to each of multiple audio tracks. The method can include generating, using a diffusion model, one or more enhanced audio tracks based on the individual timestep vectors and corresponding audio track. The method can include combining the generated audio tracks to produce a multi-track musical composition.

A system configured for multi-track music generation is described. The system can include a processor and memory coupled with the processor. The system can include instructions stored in the memory and executable by the processor to cause the system to receive a text prompt describing desired musical attributes. The system can generate, using a diffusion model, multiple audio tracks based on the text prompt, wherein each audio track can correspond to a different musical component. The system can assign individual timestep vectors respectively to each of multiple audio tracks. The system can generate, using a diffusion model, one or more enhanced audio tracks based on the individual timestep vectors and corresponding audio track. The system can combine the generated audio tracks to produce a multi-track musical composition.

Another system for multi-track music generation is described. The system can include means for receiving a text prompt describing desired musical attributes. The system can include means for generating, using a diffusion model, multiple audio tracks based on the text prompt, wherein each audio track corresponds to a different musical component. The system can include means for assigning individual timestep vectors respectively to each of multiple audio tracks. The system can include means for generating, using a diffusion model, one or more enhanced audio tracks based on the individual timestep vectors and corresponding audio track. The system can include means for combining the generated audio tracks to produce a multi-track musical composition.

A non-transitory computer-readable medium storing code music generation is described. The code can include instructions executable by a processor to generate multi-track music. The code can include instructions executable by a processor to receive a text prompt describing desired musical attributes. The code can include instructions executable by a processor to generate, using a diffusion model, multiple audio tracks based on the text prompt, wherein each audio track can correspond to a different musical component. The code can include instructions executable by a processor to assign individual timestep vectors respectively to each of multiple audio tracks. The code can include instructions executable by a processor to generate, using a diffusion model, one or more enhanced audio tracks based on the individual timestep vectors and corresponding audio track. The code can include instructions executable by a processor to combine the generated audio tracks to produce a multi-track musical composition.

Some examples of the method, systems, and non-transitory computer-readable medium described herein can further include operations, features, means, or instructions for receiving user feedback on the generated multi-track musical composition and regenerating one or more of the audio tracks based on the user feedback.

Some examples of the method, systems, and non-transitory computer-readable medium described herein can further include adding special prompt tokens to the text prompt to indicate specific generation tasks for each audio track.

Some examples of the method, systems, and non-transitory computer-readable medium described herein can further include training the diffusion model with a curriculum training strategy that progressively increases the complexity of multi-track generation tasks.

Some examples of the method, systems, and non-transitory computer-readable medium described herein can further include generating a visual representation of the multi-track musical composition to assist in the editing and refinement process.

Some examples of the method, systems, and non-transitory computer-readable medium described herein can further include incorporating user-provided audio tracks as conditioning signals to guide the generation of the multiple audio tracks.

In some examples of the method, systems, and non-transitory computer-readable medium described herein, the different musical components can comprise at least two of: bass, drums, instrument, and melody tracks.

Some examples of the method, systems, and non-transitory computer-readable medium described herein can further include receiving user feedback on one or more of the enhanced audio tracks and regenerating the one or more enhanced audio tracks based on the user feedback while maintaining consistency with other enhanced audio tracks.

In some examples of the method, systems, and non-transitory computer-readable medium described herein, regenerating the one or more enhanced audio tracks can comprise using a conditional distribution learned by the diffusion model to generate the one or more enhanced audio tracks conditioned on the other generated audio tracks.

Some examples of the method, systems, and non-transitory computer-readable medium described herein can further include adding special prompt tokens to the text prompt to indicate specific generation tasks for each audio track.

In some examples of the method, systems, and non-transitory computer-readable medium described herein, the diffusion model can be trained using a curriculum training strategy that progressively increases the complexity of multi-track generation tasks.

In some examples of the method, systems, and non-transitory computer-readable medium described herein, the text prompt can include genre-specific keywords to guide the generation of the multiple audio tracks.

In some examples of the method, systems, and non-transitory computer-readable medium described herein, the diffusion model can generate audio tracks that are temporally synchronized based on the individual timestep vectors.

In some examples of the method, systems, and non-transitory computer-readable medium described herein, the generated audio tracks can be evaluated for harmonic coherence before combining them into the multi-track musical composition.

In some examples of the method, systems, and non-transitory computer-readable medium described herein, the text prompt can include mood-specific keywords to influence the musical attributes of the generated audio tracks.

In some examples of the method, systems, and non-transitory computer-readable medium described herein, the diffusion model can adjust the audio tracks' tempo in response to the text prompt.

In some examples of the method, systems, and non-transitory computer-readable medium described herein, the generated audio tracks can be dynamically adjusted in response to real-time user feedback.

In some examples of the method, systems, and non-transitory computer-readable medium described herein, the diffusion model can incorporate rhythm-specific tokens in the text prompt to guide the generation of the audio tracks.

In some examples of the method, systems, and non-transitory computer-readable medium described herein, the generated audio tracks can be processed to match a specified audio quality standard based on the text prompt.

In some examples of the method, systems, and non-transitory computer-readable medium described herein, the diffusion model can use inter-track temporal consistency as a control signal to maintain alignment among the generated audio tracks.

### BRIEF DESCRIPTION OF THE DRAWINGS

FIG. 1 is an architecture diagram block diagram of an example of a computing system for generating multi-track music from text prompts with diffusion models in accordance with aspects of the present disclosure.

FIG. 2 illustrates a workflow for human-AI collaboration for generating multi-track music from text prompts with diffusion models in accordance with various aspects of the present disclosure.

FIG. 3 is a block diagram of an audio generation architecture for generating multi-track music from text prompts with diffusion models in accordance with various aspects of the present disclosure.

FIG. 4 illustrates various audio generation modes for generating multi-track music from text prompts with diffusion models in accordance with various aspects of the present disclosure.

FIG. 5 is a flow chart of a process for generating multi-track music from text prompts with diffusion models in accordance with various aspects of the present disclosure.

FIG. 6 is a block diagram of an apparatus for generating multi-track music from text prompts with diffusion models in accordance with various aspects of the present disclosure.

FIG. 7 is a flowchart illustrating methods that support generating multi-track music from text prompts with diffusion models in accordance with various aspects of the present disclosure.

### DETAILED DESCRIPTION

Methods, systems, and devices for generating multi-track music from text prompts with diffusion models are described in more detail below in accordance with disclosed implementations. Despite the progress in AI-driven music generation, existing models can face limitations in achieving precise control over multi-track generation. Current systems can produce composite audio mixes but fall short when it comes to composing individual tracks and integrating them in a manner that aligns with professional music production workflows. This lack of control can hinder the ability to refine specific details within individual tracks, which is essential for high-quality music production. Additionally, the complexity of modeling inter-track dependencies and ensuring temporal and harmonic coherence across multiple tracks can present a significant challenge. The disclosed implementations provide a more advanced framework that can address these issues and provide greater flexibility and control in multi-track music generation.

According to some implementations, an audio latent diffusion model can be used to generate multiple audio tracks based on text prompts. This model can operate in the audio latent space, predicting noise and iteratively removing it to create the final latent representation. The audio waveform can be converted to a lower-dimensional latent representation using an audio encoder and then reconstructed back to the original waveform through an audio decoder. The model can use a U-Net architecture, which can be adapted for audio data by replacing two-dimensional convolutions with one-dimensional convolutions tailored for audio latent representations. This U-Net architecture can consist of a sequence of blocks, including AttnDownBlock1D, UNetMidBlock1D, and AttnUpBlock1D, which can integrate residual one-dimensional convolutional layers with cross-attention transformers.

Some implementations can receive text prompts that describe desired musical attributes to guide the generation of multiple audio tracks. These text prompts can be augmented with prefix tokens to clearly define generation tasks, reducing ambiguity and improving model performance. The text prompts can specify genres, styles, instruments, tags, beats per minute, and other musical attributes.

Multiple audio tracks can be generated, each corresponding to a different musical component such as bass, drums, instrument, vocal and melody tracks. These generated audio tracks can be combined to produce a multi-track musical composition.

Individual timestep vectors can be assigned to each of the multiple audio tracks. Separate timesteps for each track can provide precise control over the generation process and enable unified distribution modeling. The conventional concept of a scalar timestep can be extended to a multi-dimensional vector, with each element determining the corresponding latent variable according to the diffusion forward process. For multiple target generation tracks, a uniform timestep can be used across these tracks to model their joint probability distribution. A timestep vector is a representation of the input data at a particular time step in a sequence. In a time series dataset, each timestep vector would contain the data for one specific time point. The model maintains a hidden state that gets updated at each timestep based on the current input and the previous hidden state. This allows the model to capture temporal dependencies in the data.

A progressive curriculum training strategy can be employed to enhance the model's capability to generate coherent multi-track audio sequences. The training can begin with single-track text-to-music generation and gradually introduce more complex multi-track tasks. Curriculum decay and task allocation can be used to manage the progression, reducing the sampling probabilities of simpler tasks over time. A strategic sampler can be employed for conditional and marginal generation, assigning non-target tracks a timestep of either zero or T to encourage conditioning or non-conditioned generation. Self-bootstrapping training can be introduced in later stages to improve generalization and align with the Human-AI co-composition workflow.

Some implementations can support an interactive generation procedure that integrates human creativity with AI capabilities. Users can input text prompts, upload, and edit specific audio tracks, which can be used as conditioning signals to guide the generation of other tracks. The iterative feedback mechanism can allow users to refine each track, enhancing the AI's understanding of human aesthetic preferences and sound quality standards. The workflow can ensure that generated tracks align with artistic intent and professional expectations, providing a sense of control over the creative process.

The performance of some implementations can be evaluated using both quantitative and qualitative metrics. Quantitative evaluation can include the CLAP score to assess alignment with text prompts and the Fréchet Audio Distance to evaluate the quality of generated mixed audio. Qualitative evaluation can employ the Relative Preference Ratio to capture human judgment of audio quality, coherence, harmony, and adherence to text prompts.

Some implementations can generate high-fidelity stereo audio tracks sampled at 48 KHz. The pre-trained audio encoder and decoder can provide robust capabilities for understanding and processing complex textual inputs. The architecture can include channel-wise concatenation of tracks and the expansion of the single-track timestep into a vector of multiple elements. Training can be conducted on high-performance hardware with optimized hyperparameters, including the AdamW optimizer, linear decay learning rate, and specific batch size and optimization settings.

By incorporating these features, some implementations can effectively model marginal, conditional, and joint distributions over multi-track music, enabling the generation of coherent, high-quality multi-track compositions based on text prompts.

The disclosed implementations can realize one or more of the following potential advantages. The described techniques can be implemented to support the creation of complex musical compositions with high fidelity and coherence. The use of text prompts can allow for intuitive control over musical attributes, enabling users to specify detailed characteristics of the desired output. The integration of individual timestep vectors can provide precise control over the generation process, ensuring that each track aligns harmoniously with others. The progressive curriculum training strategy can enhance the model's ability to handle increasingly complex tasks, resulting in more sophisticated and polished musical outputs. The interactive generation procedure can facilitate a collaborative workflow, allowing users to iteratively refine and perfect their compositions. The evaluation metrics can offer a comprehensive assessment of the model's performance, ensuring that the generated music meets high standards of quality and relevance.

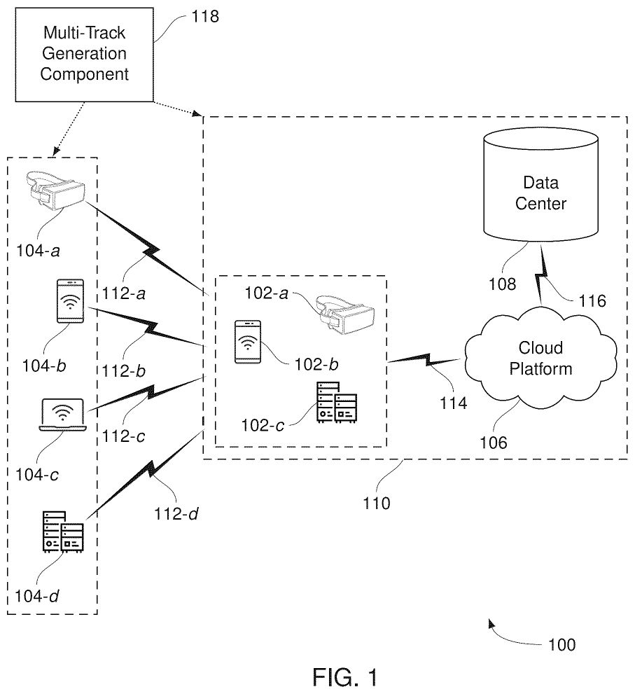

FIG. 1 illustrates an example of a system 100 that supports generating multi-track music from text prompts with diffusion models in accordance with various aspects of the present disclosure. The system 100 includes cloud clients 102, user devices 104, a cloud platform 106, and a data center 108. Cloud platform 106 can be an example of a public or private cloud network. A cloud client 102 can access cloud platform 106 over a network connection 114. The network connection 114 can include a wired connection, a wireless connection, or both. The network can implement transfer control protocol and internet protocol (TCP/IP), such as the Internet, or can implement other network protocols. A cloud client 102 can be an example of a computing device, such as a server (e.g., cloud client 102-a), a smartphone (e.g., cloud client 102-b), or a laptop (e.g., cloud client 102-c). In other examples, a cloud client 102 can be a desktop computer, a tablet, a sensor, or another computing device or system capable of generating, analyzing, transmitting, or receiving communications. In some examples, a cloud client 102 can be part of a business, an enterprise, a non-profit, a startup, or any other organization type.

A cloud client 102 can facilitate communication between the data center 108 and one or multiple user devices 104 to implement an online environment. The network connection 112 can include communications, opportunities, purchases, sales, or any other interaction between a cloud client 102 and a user device 104. The network connection 112 can include a wired connection, a wireless connection, or both. A cloud client 102 can access cloud platform 106 to store, manage, and process the data communicated via one or more network connections 112. In some cases, the cloud client 102 can have an associated security or permission level. A cloud client 102 can have access to certain applications, data, and database information within cloud platform 106 based on the associated security or permission level, and can not have access to others.

The user device 104 can include a multi-track generation component 118. The user device 104 can interact with the cloud client 102 over network connection 112. The network can implement transfer control protocol and internet protocol (TCP/IP), such as the Internet, or can implement other network protocols. The network connection 112 can facilitate transport of data via email, web, text messages, mail, or any other appropriate form of electronic interaction (e.g., network connections 112-a, 112-b, 112-c, and 112-d) via a computer network. In an example, the user device 104 can be computing device such as a wearable device 104-a, a smartphone 104-b, a laptop 104-c or a server 104-d. In other cases, the user device 104 can be another computing system. In some cases, the user device 104 can be operated by a user or group of users. The user or group of users can be a customer, associated with a business, a manufacturer, or any other appropriate organization.

Cloud platform 106 can offer an on-demand database service to the cloud client 102. In some cases, cloud platform 106 can be an example of a multi-tenant database system. In this case, cloud platform 106 can serve multiple cloud clients 102 with a single instance of software. However, other types of systems can be implemented, including—but not limited to—client-server systems, mobile device systems, and mobile network systems. In some cases, cloud platform 106 can support an online application. This can include support for sales between buyers and sellers operating user devices 104, service, marketing of products posted by buyers, community interactions between buyers and sellers, analytics, such as user-interaction metrics, applications (e.g., computer vision and machine learning), and the Internet of Things (IOT). Cloud platform 106 can receive data associated with generation of an online environment from the cloud client 102 over network connection 114 and can store and analyze the data. In some cases, cloud platform 106 can receive data directly from a user device 104 and the cloud client 102. In some cases, the cloud client 102 can develop applications to run on cloud platform 106. Cloud platform 106 can be implemented using remote servers. In some cases, the remote servers can be located at one or more data centers 108.

Data center 108 can include multiple servers. The multiple servers can be used for data storage, management, and processing. Data center 108 can receive data from cloud platform 106 via connection 116, or directly from the cloud client 102 or via network connection 112 between a user device 104 and the cloud client 102. The connection 116 can include a wired connection, a wireless connection, or both. Data center 108 can utilize multiple redundancies for security purposes. In some cases, the data stored at data center 108 can be backed up by copies of the data at a different data center (not pictured).

Server system 110 can include cloud clients 102, a cloud platform 106, a multi-track generation component 118, and a data center 108 that can coordinate with cloud platform 106 and data center 108 to implement an online environment. In some cases, data processing can occur at any of the components of server system 110, or at a combination of these components. Thus, the multi-track generation component 118 can be included in the user device 104, server system 110, or in part or in whole in both. In some cases, servers can perform the data processing. The servers can be a cloud client 102 or located at data center 108.

Some or all of the functionality attributed to the multi-track generation component 118 can be embodied or performed by one or more user devices 104, one or more components of server system 110 (e.g., cloud clients 102, a cloud platform 106, and/or a data center 108), and/or other components of system 100. The multi-track generation component 118 can receive signals and inputs from user device 104 directly. via cloud clients 102, and/or via cloud platform 106 or data center 116.

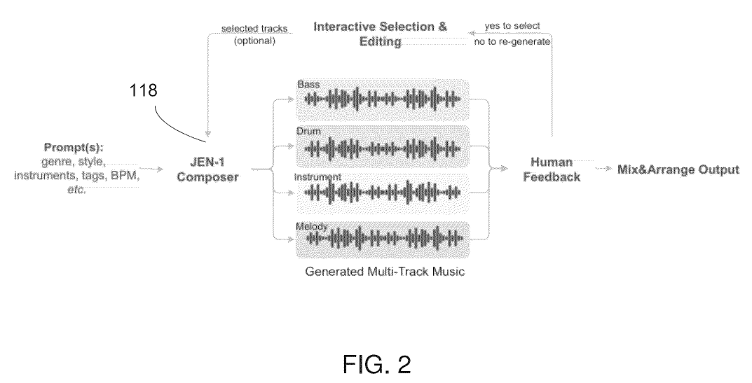

As shown in FIG. 2, and with reference to FIG. 1, the multi-track generation component 118 can receive a text prompt describing desired musical attributes from a user device 104. The multi-track generation component 118 can then generate multiple audio tracks based on the text prompt using a diffusion model incorporated in, or associated with, the multi-track generation component, with each audio track corresponding to a different musical component. Individual timestep vectors can be assigned to each of the multiple audio tracks, and the diffusion model can generate one or more enhanced audio tracks based on the individual timestep vectors and corresponding audio track. The generated audio tracks can be combined to produce a multi-track musical composition, which can be processed and stored within the cloud platform 106 or data center 108, and subsequently accessed by the user device 110 or cloud client 102. Also, as shown in FIG. 2 and discussed below, user/human feedback can be used to enhance the generated tracks.

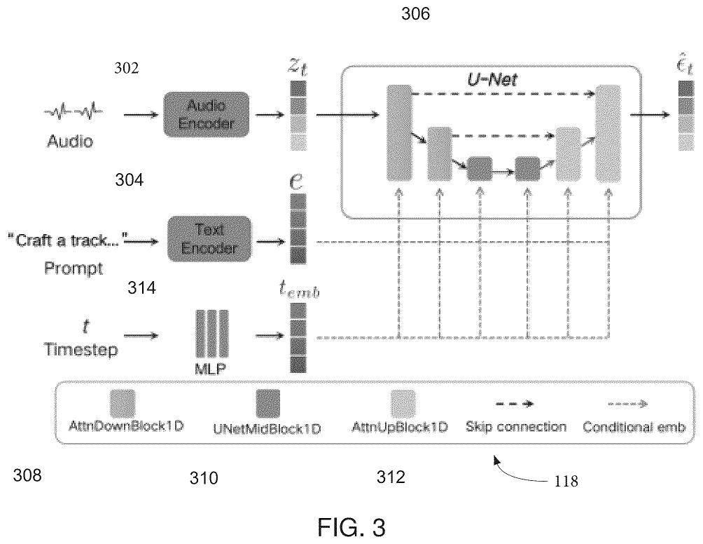

FIG. 3 shows an audio generation architecture of a multi-track generation component 118 for generating multi-track music from text prompts with diffusion models in accordance with various aspects of the present disclosure. The multi-track generation component 118 can include one or more of an audio encoder 302, a text encoder 304, a U-NET 306, an ATTNDOWNBLOCK1D 308, a UNETMIDBLOCK1D 310, an ATTNUPBLOCK1D 312, a Multi-Layer Perceptron (MLP) 314, and/or other components. An MLP is a type of neural network composed of many different interconnected perceptrons, or mathematical equations. Each perceptron is connected to other perceptrons, and connections have strengths, or weights, between them that affect the outcome of the neural network.

The audio encoder 302 can convert audio waveforms into lower-dimensional latent representations. The audio encoder 302 can be responsible for compressing the high-dimensional audio data into a more manageable form. This process can involve reducing the sequence length and dimensionality of the audio data while preserving essential features. The audio encoder 302 can work in conjunction with other components, such as the text encoder 304 and the U-NET 306, to facilitate the overall music generation process. In some implementations, the audio encoder 302 can be similar to other audio compression techniques used in neural audio processing.

The text encoder 304 can transform text prompts into embeddings that guide the generation process. Stated differently, the text encoder 304 can take textual descriptions provided by the user and convert them into a numerical format that the model can interpret. In some implementations, the text encoder 304 can utilize pre-trained language models to enhance its ability to understand complex text prompts. For example, OpenAI Embeddings, Word2Vec, GloVe (Global Vectors for Word Representation), or BERT (Bidirectional Encoder Representations from Transformers) can be used to process text descriptions into the embeddings. These embeddings can capture the semantic meaning of the text prompts, which can then be used to influence the generation of audio tracks. The text encoder 304 can interact with the audio encoder 302 and the U-NET 306 to ensure that the generated music aligns with the user's input.

The U-NET 306 can serve as the backbone for the diffusion process, tailored for audio data. The U-NET 306 can consist of a series of downsampling and upsampling layers that process the latent representations of the audio data. This architecture can allow the model to capture both local and global features of the audio, which can be crucial for generating coherent music tracks. The U-NET 306 can work closely with the AttnDownBlock1D 308, UNetMidBlock1D 310, and AttnUpBlock1D 312 to perform its functions.

The U-NET 306 can be adapted from image processing techniques to better suit the characteristics of audio data. The AttnDownBlock1D 308 can integrate residual 1D convolutional layers with cross-attention transformers. The AttnDownBlock1D 308 can be responsible for downsampling the audio data while preserving important features through residual connections. The cross-attention transformers can allow the model to focus on relevant parts of the audio data, enhancing its ability to generate high-quality music tracks. The AttnDownBlock1D 308 can be a component of the U-NET 306, working in tandem with other blocks to process the audio data. In some implementations, the AttnDownBlock1D 1D 308 can be similar to attention mechanisms used in natural language processing.

The UNetMidBlock1D 310 can function as a central processing block within the U-NET architecture. The UNetMidBlock1D 310 can serve as the bridge between the downsampling and upsampling paths of the U-NET 306. This block can process the latent representations at the bottleneck of the network, ensuring that essential features are retained and passed on to the upsampling layers. The UNetMidBlock1D 310 can interact with both the AttnDownBlock1D 308 and the AttnUpBlock1D 312 to facilitate the diffusion process. In some implementations, the UNetMidBlock1D 310 can incorporate advanced convolutional techniques to enhance its processing capabilities.

The AttnUpBlock1D 312 can combine 1D convolutional layers with cross-attention mechanisms for upsampling. The AttnUpBlock1D 312 can be responsible for reconstructing the audio data from its latent representation by progressively increasing its dimensionality. The cross-attention mechanisms can help the model focus on relevant features during the upsampling process, ensuring that the generated music tracks are coherent and high-quality. The AttnUpBlock1D 312 can work in conjunction with the UNetMidBlock1D 310 and the MLP 314 to complete the diffusion process. In some implementations, the AttnUpBlock1D 312 can be similar to upsampling techniques used in image generation models.

The MLP 314 can handle the final processing of latent representations before waveform reconstruction. The MLP 314 can take the upsampled latent representations and perform additional processing to prepare them for conversion back into audio waveforms. This component can apply various transformations to refine the latent representations, ensuring that the final output is of high quality. The MLP 314 can cooperate with the AttnUpBlock1D 312 and the audio decoder to complete the music generation process. In some implementations, the MLP 314 can be similar to fully connected layers used in other neural network architectures.

The MLP 314 can be a multi-layer perceptron used in the U-NET 306 architecture. The MLP 314 can include multiple layers of fully connected neurons that process the input data. The MLP 314 can be used to transform the latent representations and extract important features. In some implementations, the MLP 314 can be similar to the fully connected layers used in other neural network architectures for feature extraction and transformation.

In some implementations, the components shown in the image can be arranged to work together in a cohesive manner to generate multi-track music compositions. The audio encoder 302 can receive raw audio input and convert it into a lower-dimensional latent representation. This latent representation can then be processed by the U-NET 306, which can consist of several specialized blocks, including the AttnDownBlock1D 308, the UNetMidBlock1d 310, and the AttnUpBlock1D 312. These blocks can perform various operations such as down-sampling, intermediate processing, and up-sampling of the latent audio features.

The text encoder 304 can process text prompts that describe the desired musical attributes and convert them into embeddings. These embeddings can be used as conditioning inputs for the U-NET 306, guiding the generation process. The MLP 314 can generate timestep embeddings that are crucial for handling the temporal aspects of the audio tracks. These timestep embeddings, along with the text embeddings and latent audio representations, can be fed into the U-NET 306, which iteratively refines the noise to generate the final latent audio representation. The combined output can then be decoded back into audio waveforms, resulting in a coherent multi-track musical composition.

Timestep embeddings encode the specific timestep in the diffusion process. This helps the model understand the progression of the denoising process, which is essential for generating high-quality outputs. Timestep embeddings can be created using sinusoidal functions. This method ensures that each timestep has a unique representation, which can be easily integrated into the model. The sinusoidal embeddings are designed to capture the periodic nature of the timesteps, making them effective for models that rely on sequential data. Timestep embeddings can added to the input data at each timestep. This allows the model to condition its predictions on the current stage of the diffusion process, improving the accuracy and quality of the generated outputs.

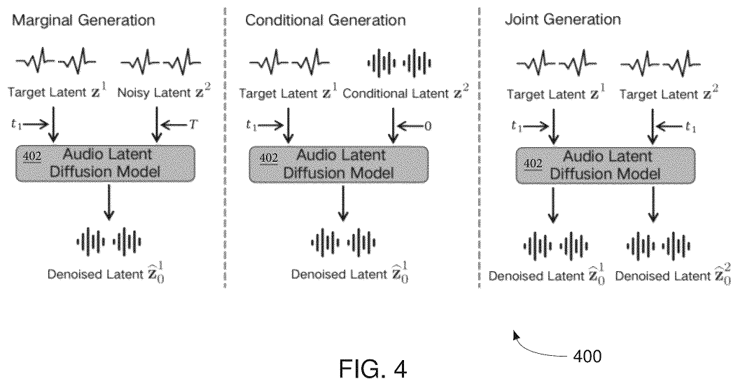

FIG. 4 illustrates audio generation modes 400 which support techniques for generating multi-track music from text prompts with diffusion models in accordance with various aspects of the present disclosure. As depicted in FIG. 4, the audio generation modes 400 can include one or more of an audio latent diffusion model 402, a target latent, a noisy latent, a conditional latent, a denoised latent 410, and/or other components. A “latent” is a term of art in data processing that refers to a hidden or underlying variable(s) that is/are inferred from the data. The model can support three generation modes: Marginal Generation, Conditional Generation, and Joint Generation. In Marginal Generation, the target track can be generated based only on the text prompt, without constraints from other tracks. In Conditional Generation, the target track can be generated while considering the temporal alignment and harmonic coherence of other non-target tracks. In Joint Generation, multiple tracks can be generated simultaneously, focusing on maintaining inter-track consistency and harmony.

The audio latent diffusion model 402 can generate high-fidelity audio samples from text prompts. The audio latent diffusion model 402 can be a generative model that produces high-quality samples through iterative denoising. The process can begin by gradually corrupting the original data with Gaussian noise over a series of timesteps in a forward process. The audio latent diffusion model 402 can then aim to recover the original data by iteratively denoising the noisy samples. In some implementations, the audio latent diffusion model 402 can be similar to the Jen-1 model, which operates in the audio latent space and predicts noise to generate the final latent representation.

The target latent can represent the desired audio output at a specific timestep. The target latent can be a lower-dimensional representation of the audio waveform, which is mapped from the original audio data. The target latent can be used to guide the generation process towards producing the desired audio output. In some implementations, the target latent can be similar to the latent representations used in the Jen-1 model described in U.S. Patent Publication No. US 2025-0054473 A1, which are encoded from the audio data and then reconstructed back to the original waveform.

The noisy latent can include Gaussian noise added to the audio data during the forward process. The noisy latent can be generated by corrupting the original audio data with Gaussian noise over a series of timesteps. The noisy latent can serve as an intermediate representation that the diffusion model aims to denoise to recover the original audio data. In some implementations, the noisy latent can be similar to the noisy samples generated in the forward process of the Jen-1 model, which are then denoised in the reverse process to generate high-fidelity audio samples.

The conditional latent can guide the generation of the target track based on other tracks. The conditional latent can be an embedding of conditioning inputs, such as text prompts or other audio tracks. The conditional latent can be used to influence the generation process by providing additional context or constraints. In some implementations, the conditional latent can be similar to the conditioning signals used in the Jen-1 model, which guide the generation of audio tracks based on text prompts and inter-track dependencies.

The denoised latent can represent the refined audio output after the reverse diffusion process. The denoised latent 41 can be obtained by iteratively denoising the noisy latent representations generated during the forward process. The denoised latent can be a lower-dimensional representation that can be reconstructed back to the original audio waveform. In some implementations, the denoised latent can be similar to the final latent representation generated by the Jen-1 model, which is then decoded to produce high-fidelity audio samples.

Returning to FIG. 3, the AttnDownBlock1D 308 can be a component of the U-NET 306 architecture used in the Jen-1 model. The AttnDownBlock1D 308 can include residual 1D convolutional layers with cross-attention transformers. The AttnDownBlock1D 308 can be responsible for downsampling the input latent representations while preserving important features. In some implementations, the AttnDownBlock1D 308 can be similar to the downsampling blocks used in other U-NET architectures for image processing.

The AttnUpBlock1D 312 can be a component of the U-NET 306 architecture used in the Jen-1 model. The AttnUpBlock1D 312 can include residual 1D convolutional layers with cross-attention transformers. The AttnUpBlock1D 312 can be responsible for upsampling the latent representations to their original dimensions. In some implementations, the AttnUpBlock1D 312 can be similar to the upsampling blocks used in other U-NET architectures for image processing.

The audio encoder 302 of FIG. 3 can map the audio waveform to a lower-dimensional latent representation. The audio encoder 302 can be a neural network that processes the input audio data and compresses it into a latent space. The audio encoder 302 can be used to reduce the dimensionality of the audio data while preserving important features. In some implementations, the audio encoder 302 can be similar to the encoder used in the Jen-1 model, which maps the audio waveform to a latent representation that can be used for generation.

Returning to FIG. 2, the process flow can use human feedback can guide the generation process by providing input on the generated audio tracks. The human feedback can be used to refine and improve the generated audio tracks based on user preferences. The human feedback can be integrated into the Human-AI co-composition workflow, allowing users to iteratively select, edit, or upload tracks. In some implementations, the human feedback can be similar to the feedback mechanism disclosed in U.S. patent application Ser. No. 18/764,610 and U.S. Patent Publication No. US 2025-0054473 A1, which allows users to influence the generation process through iterative refinement.

The multi-track generation component 118 can be a unified framework for high-fidelity multi-track music generation. multi-track generation component 118 can use an audio latent diffusion model to generate multiple audio tracks based on text prompts and inter-track dependencies. The multi-track generation component 118 can support marginal, conditional, and joint generation modes, allowing for flexible and controllable music creation. In some implementations, the multi-track generation component 118 can be similar to the Jen-1 model, which leverages text prompts and inter-track dependencies to generate coherent, high-quality multi-track music.

In some implementations, the components shown in the image can be arranged to facilitate different modes of audio generation. The audio latent diffusion model 402 of FIG. 4 can serve as the central processing unit, receiving various latent inputs and generating denoised outputs. The target latent can represent the initial latent state of the audio track that is intended to be generated or refined. The noisy latent can correspond to a perturbed version of the target latent, which can be used in marginal generation to simulate Gaussian noise.

In some implementations, the conditional latent can be used to guide the generation process by providing additional context or constraints, particularly in conditional generation mode. The audio latent diffusion model 402 can process these inputs, applying the diffusion process to transition from noisy latent states to denoised latent states. The denoised latent can represent the final output of the model, which can be a refined version of the target latent, now free of noise and aligned with the desired musical attributes. This arrangement allows the model to handle different generation tasks by manipulating the timestep vectors and latent states accordingly.

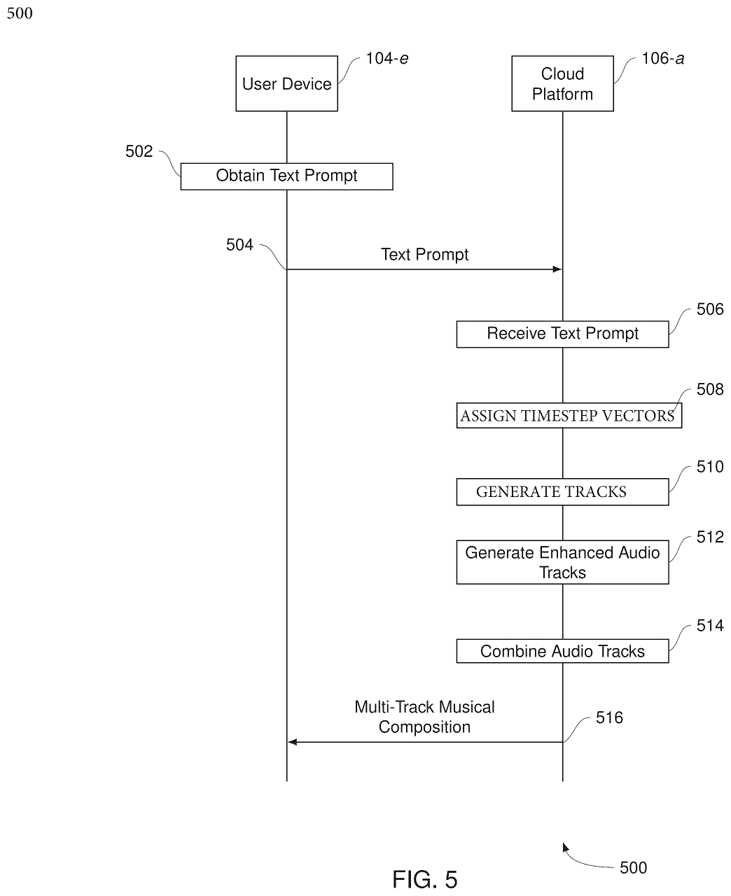

FIG. 5 illustrates an example of a process flow 500 for generating multi-track music from text prompts with diffusion models in accordance with aspects of the present disclosure. In some examples, the process flow 500 can implement aspects of the system 100 of FIG. 1. For example, the process flow 500 can include a user device 104-e and a cloud platform 106-a, which can be examples of corresponding devices described herein. In some implementations, a user device 104-e receives a text prompt describing desired musical attributes and sends it to a cloud platform 106-a, which then uses a diffusion model to generate multiple audio tracks corresponding to different musical components, assigns individual timestep vectors to each track, generates enhanced audio tracks based on these vectors, and combines the tracks to produce a multi-track musical composition.

At 502, the user device 104-e can obtain a text prompt describing desired musical attributes. For example, the text prompt can include specific genres, such as jazz or classical, to guide the musical composition. In some implementations, the text prompt can specify particular instruments, like piano or guitar, to be featured in the generated music. The text prompt can also describe the mood or tempo of the desired music, such as a cheerful and fast-paced track. For example, a text prompt could be “generate a song in the jazz genre, including guitar, saxophone, and drums in a fast-paced tempo”. Further, one or more audio tracks can be uploaded as conditioning signals to guide track generation. For example, users might upload a drum track to guide the generation of bass. This human-provided guidance is part of the system's flexibility.

At 504, the user device 104-e can transmit the text prompt to the cloud platform 106-a. For example, the text prompt can describe musical attributes such as genre, style, instruments, and tempo. In some implementations, the text prompt can include specific keywords or themes to guide the generation process. The user device 104-e can format the text prompt to include special tokens that indicate particular generation tasks for the cloud platform 106-a.

At 506, the cloud platform 106-a can receive the text prompt describing desired musical attributes, and any optional music tracks uploaded as conditioning signals.

At 508, the cloud platform 106-a can assign individual timestep vectors respectively to each of multiple audio tracks. For example, in some implementations, the cloud platform 106-a can assign a unique timestep vector to a bass track, a different timestep vector to a drum track, and yet another timestep vector to a melody track. In some implementations, the cloud platform 106-a can determine the timestep vectors based on the specific characteristics of the audio tracks, such as their tempo or rhythm. In some implementations, the cloud platform 106-a can adjust the timestep vectors dynamically during the generation process to maintain temporal alignment and coherence among the audio tracks.

At 510, the cloud platform 106-a can generate, using a diffusion model, multiple audio tracks based on the text prompt, wherein each audio track can correspond to a different musical component. For example, in some implementations, the cloud platform 106-a can generate a bass track that can align with the rhythmic attributes described in the text prompt. In some implementations, the cloud platform 106-a can generate a melody track that can reflect the harmonic structure specified in the text prompt. In some implementations, the cloud platform 106-a can generate a drum track that can match the tempo and style indicated in the text prompt.

At 512, the cloud platform 106-a can generate, using a diffusion model, one or more enhanced audio tracks based on the individual timestep vectors and corresponding audio track, when at least one audio track has been used as a conditioning signal. For example, in some implementations, the cloud platform 106-a can generate an enhanced melody track by refining the initial melody track with additional harmonic elements based on a music track conditioning signal. In other implementations, the cloud platform 106-a can generate an enhanced drum track by incorporating more complex rhythmic patterns while maintaining the original tempo. The cloud platform 106-a can also generate an enhanced bass track by adding depth and richness to the existing bassline, ensuring it complements the other audio tracks.

At 514, the cloud platform 106-a can combine the generated audio tracks to produce a multi-track musical composition. For example, the cloud platform 106-a can align the timing of the bass, drums, instrument, and melody tracks to ensure they are synchronized. In some implementations, the cloud platform 106-a can adjust the volume levels of the individual tracks to maintain a balanced mix. The cloud platform 106-a can also apply effects such as reverb or equalization to the combined tracks to enhance the overall sound quality of the multi-track musical composition.

At 516, the cloud platform 106-a can transmit the multi-track musical composition to the user device 104-e. For example, the cloud platform 106-a can send the composition as a downloadable file format such as MP3 or WAV. In some implementations, the cloud platform 106-a can stream the multi-track musical composition directly to the user device 104-e for immediate playback. The user device 104-e can receive notifications or alerts indicating the availability of the new musical composition.

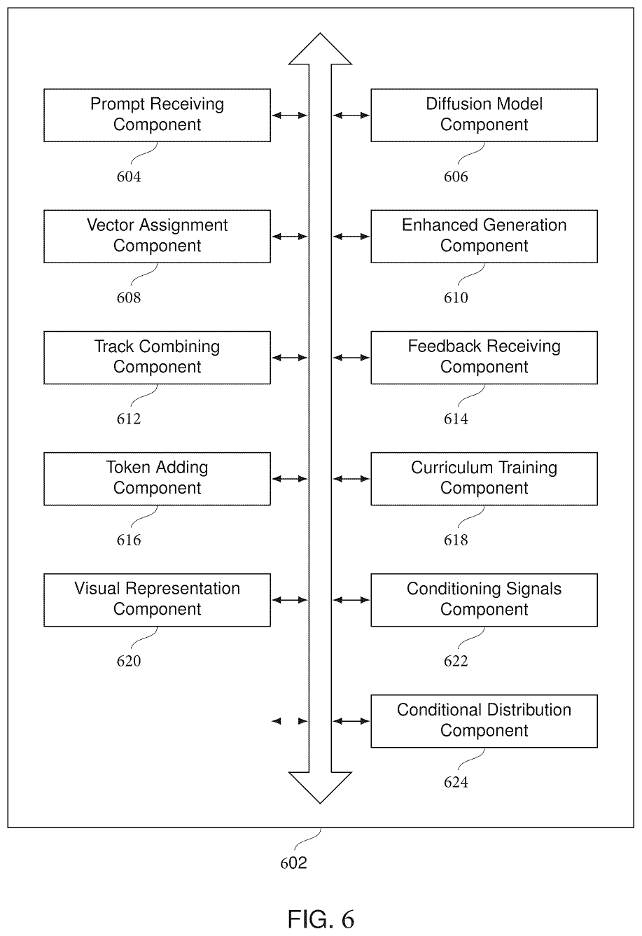

FIG. 6 is a block diagram of an apparatus 602 that implements multi-track generation component 118 for generating music from text prompts with diffusion models in accordance with disclosed implementations. The apparatus can include various modules as described below. Each of these modules can be in communication with one another (e.g., via one or more buses). In some cases, the apparatus 602 can be an example of a user terminal, a database server, or a system containing multiple computing devices. The “modules” and “components” described herein can be executable code recorded on non-transitory media and are segregated and described in terms of functions performed thereby. However, the modules need not be represented be separate and distinct code and can be distributed amongst plural media and/or devices.

The device can include one or more of a prompt receiving component 604, a diffusion model component 606, a vector assignment component 608, an enhanced generation component 610, a track combining component 612, and/or other components.

The prompt receiving component 604 can be configured to receive a text prompt describing desired musical attributes. The diffusion model component 606 can be configured to generate, using a diffusion model, multiple audio tracks based on the text prompt, wherein each audio track corresponds to a different musical component. The vector assignment component 608 can be configured to assign individual timestep vectors respectively to each of multiple audio tracks. The enhanced generation component 610 can be configured to generate, using a diffusion model, one or more enhanced audio tracks based on the individual timestep vectors and corresponding audio track. The track combining component 612 can be configured to combine the generated audio tracks to produce a multi-track musical composition.

The diffusion model component 606 can be configured to generate, using a diffusion model, multiple audio tracks based on the text prompt, wherein each audio track can correspond to a different musical component. In some implementations, the diffusion model can generate tracks such as bass, drums, and melody. The diffusion model can be trained to handle complex multi-track generation tasks. The timestep vectors can be used to control the generation process of each track. The timestep vectors can be independently learned for each track to ensure precise control. In some implementations, the timestep vectors can be used to control the generation process of each track independently. The vectors can allow for precise adjustments to the timing and synchronization of the audio tracks.

The enhanced generation component 610 can be configured to generate, using a diffusion model, one or more enhanced audio tracks based on the individual timestep vectors and corresponding audio track. In some implementations, the enhanced audio tracks can be generated by conditioning on other tracks. The diffusion model can use a conditional distribution to generate the enhanced audio tracks. In some implementations, the audio quality of the generated tracks can be enhanced. The enhanced generation component 710 can use the timestep vectors to maintain consistency with the original audio tracks.

The track combining component 612 can be to combine the generated audio tracks to produce a multi-track musical composition. In some implementations, the combination process can ensure temporal alignment and harmonic coherence. The combined tracks can result in a cohesive musical piece. The track combining n component 712 can ensure that the tracks are harmoniously aligned. The component can use the generated audio tracks to create a cohesive musical piece.

Further, the device can include one or more of a feedback receiving component 614, a token adding component 616, a curriculum training component 618, a visual representation component 620, a conditioning signals component 622, a conditional distribution component 624, and/or other components. Each of these components can communicate, directly or indirectly, with one another (e.g., via one or more buses).

The feedback receiving component 614 can be configured to receive user feedback on the generated multi-track musical composition. In some implementations, the feedback can include comments on the harmony and rhythm of the tracks. In some implementations, the feedback can be provided through an interactive interface where users can rate the quality of individual tracks. The feedback receiving component 614 can regenerate one or more of the audio tracks based on the user feedback. In some implementations, the regeneration process can involve adjusting the tempo of the tracks to match user preferences. In some implementations, the regeneration can include modifying the instrument sounds to better align with the feedback received.

The token adding component 616 can be configured to add special prompt tokens to the text prompt to indicate specific generation tasks for each audio track. In some implementations, these special prompt tokens can specify the desired genre or style for the bass track. In some implementations, the special prompt tokens can include instructions for generating drum patterns that align with a specified tempo.

The curriculum training component 618 can be configured to train the diffusion model with a curriculum training strategy that can progressively increase the complexity of multi-track generation tasks. The curriculum training strategy can begin with simpler tasks such as generating single-track audio based on text prompts. The strategy can then introduce more complex tasks, such as generating multiple tracks with specific inter-track dependencies. In some implementations, the curriculum training component 718 can adjust the difficulty of tasks based on the model's performance, ensuring that the model can handle increasingly complex generation scenarios.

The visual representation component 620 can be configured to generate a visual representation of the multi-track musical composition to assist in the editing and refinement process. In some implementations, the visual representation can include waveform displays for each track, allowing users to see the amplitude variations over time. In some implementations, the visual representation can incorporate color-coded tracks to distinguish between different musical components, such as bass, drums, and melody. The visual representation can provide zoom and pan functionalities, enabling users to focus on specific sections of the composition for detailed editing.

The conditioning signals component 622 can be configured to incorporate user-provided audio tracks as conditioning signals to guide the generation of the multiple audio tracks. The user-provided audio tracks can include specific instruments or vocal tracks that can be used to influence the generated music. In some implementations, the conditioning signals can be adjusted to match the desired style or genre specified in the text prompt. The conditioning signals component 722 can allow for real-time adjustments to the conditioning signals based on user feedback during the generation process.

The musical components can include at least two of: bass, drums, instrument, and melody tracks. As an example, the bass track can be generated to align with the rhythmic structure of the drums. In some implementations, the instrument track can include variations such as guitar or piano to match the desired musical style. In some implementations, the melody track can be designed to harmonize with the bass and instrument tracks.

The conditional distribution component 624 can be configured to regenerate one or more enhanced audio tracks based on user feedback while maintaining consistency with other enhanced audio tracks. In some implementations, the user feedback can include specific comments on the harmony and rhythm of the tracks. In some implementations, the feedback can be provided through an interactive interface that allows users to highlight sections of the audio tracks that can require adjustments.

Regenerating the one or more enhanced audio tracks can comprise using a conditional distribution learned by the diffusion model to generate the one or more enhanced audio tracks conditioned on the other generated audio tracks. In some implementations, the diffusion model can utilize a learned conditional distribution to ensure that the regenerated tracks align with the overall musical composition. In some implementations, the model can adjust the timbre and dynamics of the regenerated tracks to match the user-provided feedback while maintaining coherence with the other tracks.

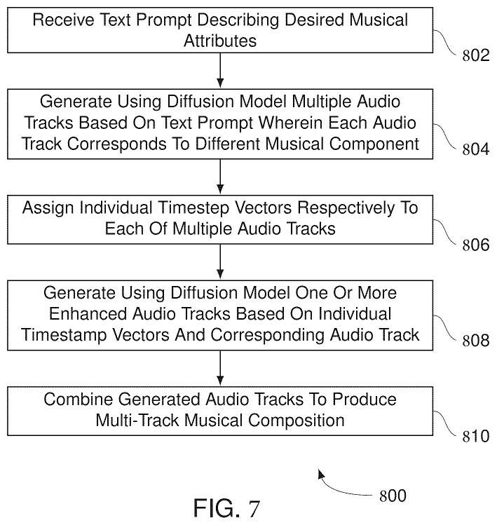

FIG. 7 is a flowchart illustrating a method 700 for generating multi-track music from text prompts with diffusion models in accordance with various aspects of the present disclosure. The operations of the method 700 can be implemented by one or more components of a networked computing system as described herein. Components of the networked computing system can execute a set of instructions to control the functional elements of the modules/component(s) to perform the described functions. Additionally, or alternatively, the one or more components of a networked computing system can perform aspects of the described functions using special-purpose hardware.

At 702, the method can include receiving a text prompt describing desired musical attributes. The operations of 802 can be performed in accordance with examples as disclosed herein. In some examples, aspects of the operations of 602 can be performed by a prompt receiving component 604 as described with reference to FIG. 6. Step 702 can also include uploading one or more audio tracks as additional conditioning signals for guiding track generation.

At 704, the method can include generating, using a diffusion model, multiple audio tracks based on the text prompt, wherein each audio track corresponds to a different musical component. The operations of 804 can be performed in accordance with examples as disclosed herein. In some examples, aspects of the operations of 704 can be performed by a diffusion model component 606 as described with reference to FIG. 6.

At 706, the method can include assigning individual timestep vectors respectively to each of multiple audio tracks. The operations of 706 can be performed in accordance with examples as disclosed herein. In some examples, aspects of the operations of 806 can be performed by a vector assignment component 608 as described with reference to FIG. 6.

At 708, the method can include generating, using a diffusion model, one or more enhanced audio tracks based on the individual timestep vectors and corresponding audio track. The operations of 708 can be performed in accordance with examples as disclosed herein. In some examples, aspects of the operations of 708 can be performed by an enhanced generation component 610 as described with reference to FIG. 6.

At 710, the method can include combining the generated audio tracks to produce a multi-track musical composition. The operations of 710 can be performed in accordance with examples as disclosed herein. In some examples, aspects of the operations of 710 can be performed by a track combining component 612 as described with reference to FIG. 6.

Disclosed implementations can leverage known computing components, including processors, memory devices and database controllers. Memory can include random-access memory (RAM) and read-only memory (ROM). The memory can store computer-readable, computer-executable software including instructions that, when executed, cause the processor to perform various functions described herein. The memory 810 can include a basic input/output system (BIOS) which can control basic hardware or software operation such as the interaction with peripheral components or devices. Processors can include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). The processor(s) can be configured to execute computer-readable instructions stored in a memory 810 to perform various functions (e.g., functions or tasks supporting generating multi-track music from text prompts with diffusion models).

A more specific example of music generation in accordance with disclosed implementations is set forth blow. To enable the model to handle multi-track input and output for joint modeling, modifications have been made to Jen-1's single-track architecture. As elaborated below, the input-output representation, timestep vectors, and prompt prefixes are adapted to fit multi-track distributions efficiently using a single model.

Multi-track Input-Output Representation. We extend the single-track input paradigm of Jen-1 to accommodate multitrack inputs, denoted as

$$X = [ {x}_{0}^{1} , … , {x}_{0}^{K} ] ,$$

where

$${x}_{0}^{i}$$

represents the i-th track and K denotes the total number of tracks. Each track undergoes encoding into the audio latent space, yielding latent representations

$${z}_{0}^{i} = {f}_{ϕ} ( {x}_{0}^{i} ) ∈ {ℝ}^{D \times {S}^{′}}$$

prior to being inputted to the audio latent diffusion model. These latent representations are concatenated along the channel dimension to form the input latent variables Z∈R^{KD×S}. During inference, the output of the audio latent diffusion model is split into K tracks, with each denoised latent variable reconstructed into waveform via the pre-trained audio decoder, denoted as [symbol] =g_{ψ}( [symbol] ). The extension of the input-output representation to multi-track enables explicit modeling of inter-track dependencies and consistency, crucial for high-quality multi-track generation that is absent in single-track models.

Individual Timestep Vectors. Introducing separate timesteps for each track not only provides precise control over the generation process but also enables unified distribution modeling. This is achieved by extending the scalar timestep tin Jen-1 to a multi-dimensional vector T=[t₁, . . . ,t_{K}]. Each tᵢ determines the corresponding latent variable zⁱ in Z=[z¹ . . . z^{K}] according to the diffusion forward process defined in Equation (1). In the diffusion model, these timesteps are independently learned for each track and concatenated to form the conditional embedding. The process is formalized as follows:

$${z}^{i} = \{ \begin{matrix}{z}_{T}^{i} , & if {t}_{i} = T \\ {z}_{0}^{i} , & if {t}_{i} = 0 \\ {z}_{l}^{i} , & if 0 < {t}_{i} < T\end{matrix}$$

For k≥2 target generation tracks, we adopt a uniform timestep t across these tracks, mirroring the modeling of their joint probability distribution. Specifically, if k<K, two modes are considered for the remaining (K−k) tracks. Firstly, the conditional generation mode sets all timesteps to 0, representing latent variables corresponding to original waveforms, akin to conditional generation. Here, the corresponding latent variables and timestep vectors are denoted as Z_{c} and T_{c}, respectively. Secondly, the unconditional generation mode involves fixing all non-target timesteps to T, indicating perturbation of corresponding latent variables to approximate Gaussian random noise, akin to marginal generation. Correspondingly, the latent variables and timestep vectors are labeled as Zₘ and Tₘ. During loss computation, emphasis is laid solely on the channels corresponding to the target tracks, while inference benefits from the ClassifierFree Guidance (CFG) technique (Ho and Salimans 2022). Specifically, if k<K, the alignment across tracks and generation quality are enhanced via the expression:

$$ϵ = ( 1 - λ ) ϵθ ( {Z}_{m} , e , {T}_{m} ) + {λϵ}_{θ} ( {Z}_{c} , e , {T}_{c} ) ,$$

where λ denotes the guidance scale.

Traditional text prompts, which typically describe the musical content and style, are enhanced by integrating task-specific tokens as prefix prompts. These tokens, which are described above, act as explicit directives, similar to command flags in programming, providing clear and concise instructions regarding the generation task at hand. By using specific prefixes like “[bass & drum generation]”, we direct the model's focus to the production of target tracks, such as bass and drums. This approach not only specifies the generation objectives but also significantly diminishes ambiguity, thus improving both the fidelity and relevance of the generated content.

A progressive curriculum training strategy, designed to systematically enhance the model's capability to generate coherent multi-track audio sequences while accommodating varying levels of conditioning and noise injection, is applied. This strategy includes curriculum decay and task allocation, a strategic sampler for conditional and marginal generation modes, and self-bootstrapping training to improve model generalization.

The training begins with single-track text-to-music generation, establishing a strong foundation for the model. As the model advances, more complex multi-track tasks are gradually introduced. This progression is carefully managed by reducing the sampling probabilities of simpler tasks, allowing the model to develop the ability to generate harmonically aligned tracks across multiple channels. Each task involves multi-track audio input and output, with latent representations configured as described in Equation (5). During this phase, the model's learning is focused on critical aspects by computing losses only for target tracks, while non-target tracks are masked. This structured approach facilitates efficient learning, enabling the model to generate high-fidelity audio compositions.

Curriculum Decay and Task Allocation. The curriculum starts with single-track (k=1) tasks, focusing on conditional generation using other tracks as signals or simpler marginal generation tasks. As training progresses, the focus shifts towards multi-track generation (2≤k<K), with increased sampling probabilities for more complex tasks over time. Ultimately, the curriculum incorporates joint generation tasks (k=K) driven solely by text prompts.

A strategic sampler is employed when fewer target tracks are generated than available (k<K). The sampler assigns nontarget tracks a timestep of either 0 or T: with probability p₁, a timestep of 0 is chosen to encourage conditioning, and with probability 1−p₁, a timestep of Tis selected for nonconditioned generation. This approach allows the model to effectively learn both conditional and marginal generation, preparing it for CFG technique implementation during inference and enhancing its overall performance in generating coherent music tracks.

Incorporation of Self-Bootstrapping Training. In later training stages, self-bootstrapping is introduced with a probability p₂ to improve generalization and align with the Human-AI co-composition workflow. During this phase, tracks generated by a teacher model—using an exponential moving average of the model's parameters—replace a portion of the ground truth-aligned conditional input tracks. This technique refines the model's alignment and synchronization capabilities, expands the training dataset, and enhances generalization, which is crucial for performance in real-world, interactive environments.

During inference, the model supports the conditional generation of multiple tracks given 0 to K−1 input tracks. To facilitate Human-AI collaborative music creation, an interactive generation procedure, outlined in Algorithm 1, below was used. The proposed interactive inference approach effectively integrates human creativity with AI capabilities, enabling a collaborative music generation process. This workflow offers three primary benefits:
Enhanced Refinement. The iterative feedback mechanism allows users to refine each track, enabling nuanced improvements that purely AI-driven generation may struggle to achieve. By selecting and refining satisfactory tracks, users steer the generation process toward desired outcomes, filtering out low-quality outputs.
Alignment with Human Aesthetics. The interaction between human creators and the model enhances the AI's understanding of human aesthetic preferences and sound quality standards. This ongoing collaboration ensures that the generated tracks align more closely with artistic intent and professional expectations.
Creative Control and Engagement. The collaborative experience empowers human producers, providing a sense of control over the creative process. By balancing AI-driven generation with human input, the workflow ensures that both improvisation and structural coherence are maintained, enabling the realization of creative visions with AI assistance.

Algorithm 1:

| 1: | Input: Text prompt, user-provided tracks S (optional) |
|---|---|
| 2: | Output: Set of selected and refined tracks S |
| 3: | e ← Embedding of the given prompt |
| 4: | while S is empty do |
| 5: | # Joint Generation |
| 6: | Model.GenerateTracks(e) |
| 7: | S ← User.selectAndRefineTracks |
| 8: | end while |
| 9: | while not all K tracks are satisfactory do |
| 10: | # Using the CFG technique defined in Equation (6) |
| Model.GenerateTracks(S,e) | |
| 12: | # Update S |
| 13: | S ← S ∪ User.selectAndRefineTracks |
| 14: | end while |

Extensive experiments were conducted to evaluate the capabilities of the model, focusing on its performance across various dimensions to understand its potential in real-world applications.

Like Diff-A-Riff (Nistal et al. 2024), high-quality audio generation suitable for professional use, which requires training on proprietary datasets due to their superior sound quality compared to open-source MIDI-based data, was prioritized. An 800-hour private studio recording dataset comprising five temporally aligned tracks: bass, drums, instrument, melody, and the final mix was utilized. Each track was annotated with metadata, including genres (e.g., blues, folk), instruments (e.g., guitar, piano), moods (e.g., cheerful, romantic), tempo, keywords, and themes. The dataset was divided into 640 hours for training and 160 hours for testing. Tracks were randomly sliced into aligned segments of varying lengths to ensure the model learns inter-track dependencies, enabling generation of cohesive, high-quality multi-track music guided by text prompts. The evaluation employs both quantitative and qualitative metrics to assess the model's performance.

For quantitative evaluation, the CLAP score (Elizalde et al. 2023) was used to evaluate how well the generated music aligns with the intended semantic content of the text prompts. Higher CLAP scores indicate better alignment. These scores were computed for both individual tracks and the aggregated mixed track (MIXED CLAP) to assess the effectiveness of the model in adhering to textual descriptions. For comparison models, we apply Demucs (Defossez 2021; Rouard, Massa, and′ Defossez 2023) to separate tracks before calculating their′ individual CLAP scores. We also use Frechet Audio Distance (FAD) (Roblek et al. 2019) as a metric. The quality of the generated mixed audio was determined by comparing it to mixed audio from both the proprietary dataset and the public Slakh2100 dataset (Manilow et al. 2019) using the FAD metric (lower is better), computed with VGGish embeddings (Hershey et al. 2017). This comparison was done without fine-tuning, providing a zero-shot evaluation. This approach ensures a fair and consistent evaluation of the contextual relevance and musical fidelity of the generated outputs across different methods.

Qualitative evaluation, was accomplished by employing the Relative Preference Ratio (RPR) to capture human judgment of audio quality. Multiple raters evaluate pairs of audio samples—one generated by the model and the other by a comparison model—without knowing the origin of each sample. Raters assess based on audio quality, coherence, harmony, and adherence to the text prompt. The RPR is recorded as a percentage, where 0% indicates no preference for the model's output, and 100% indicates complete preference. This metric captures subjective preferences, providing insight into the perceived quality and effectiveness of the generated music. Integrating CLAP scores, FAD, and RPR, resulted in a comprehensive evaluation framework that balances objective alignment with subjective human perception, ensuring a thorough assessment of the model's strengths and areas for improvement.

The test task involved generating four distinct audio tracks: bass, drums, instrument, and melody, alongside a synthesized mixed track. All tracks are high-fidelity stereo audio sampled at 48 KHz. The the 48k version of the pre-trained EnCodec (Defossez et al. 2022) was utilized resulting in a latent space representation of 150 frames per second, each with 128 dimensions. The volumes of individual tracks were adjusted to ensure consistent relative loudness before encoding. For text encoding, the pre-trained Flan-T5-Large model (Chung et al. 2024), which provides robust capabilities for understanding and processing complex textual inputs, was utilized. The architecture of model was built upon a 1D UNet backbone (Ronneberger, Fischer, and Brox 2015), with modifications to the Jen1 model (Li et al. 2024), as outlined above. These modifications include the channel-wise concatenation of tracks and the expansion of the single-track timestep into a vector of four elements, enabling the model to effectively handle and generate cohesive multi-track music.

Training follows a progressive curriculum strategy. Initially, the probability for single-track generation tasks is set to 1/K, with K=4, where each track is independently considered as a target track. As training progresses, these probabilities gradually decay, allowing for the introduction of more complex multi-track generation tasks. Eventually, all task types are covered, with the probability for each generation scenario (whether a track is a target track or not) set to 1/(2^{K}−1). Sampler settings for conditional and marginal generation are optimized with p₁=0.8. After 300 epochs, self-bootstrapping training is introduced with a probability p_{2=0.5}. We determined the optimal value for the guidance scale parameter λ=7 through a grid search. Training was conducted on two NVIDIA A100 GPUs, with hyperparameters including the AdamW optimizer (Loshchilov and Hutter 2018), a linear decay learning rate starting at 3e-5, a batch size of 12 per GPU, and optimization settings of β₁=0.9, β₂=0.95, weight decay of 0.1, and a gradient clipping threshold of 0.7.

A comprehensive comparison was conducted between leading text-to-music generation models, including MusicLM (Agostinelli et al. 2023), MusicGen (Copet et al. 2024), and Jen-1 (Li et al. 2024) (which primarily focus on singletrack generation) and the test model, which supports multi-track generation with flexible conditional control, enabling track-wise generation and enhanced inter-track alignment. As shown in Table 1, JEN-1 Composer achieves superior CLAP scores across individual tracks and the mixed track, highlighting its ability to generate music that closely adheres to text prompts while maintaining inter-track coherence. Additionally, the RPR metric results confirm a strong user preference for JEN-1 Composer's outputs, demonstrating its effectiveness in delivering high-quality compositions.

TABLE 1

| CLAP | | | | | | RPR |
|---|---|---|---|---|---|---|
| Model | Bass | Drums | Instrument | Melody | Mixed | Mixed |
| MusicLM | 0.16 | 0.17 | 0.23 | 0.28 | 0.28 | 27% |
| MusicGen | 0.17 | 0.15 | 0.25 | 0.33 | 0.35 | 36% |
| Jen-1 | 0.19 | 0.16 | 0.29 | 0.32 | 0.36 | 40% |
| Test Model | 0.21 | 0.18 | 0.29 | 0.36 | 0.39 | — |
| of Disclosed | | | | | | |
| Implementation | | | | | | |

Ablation studies underscore the significance of each component within the test model framework. As summarized in Table 2 below, a baseline model featuring a four-track input-output configuration inspired by Jen-1 (Li et al. 2024) was compared with the same model in which enhancements of the disclosed implementations were incrementally introduced. Using individual timestep vectors for each track was pivotal in effectively modeling both marginal and conditional distributions, resulting in notably higher CLAP scores for individual tracks.

| CLAP | | | | | | RPR |
|---|---|---|---|---|---|---|
| Methods | Bass | Drums | Instrument | Melody | Mixed | Mixed |
| baseline | 0.20 | 0.18 | 0.20 | 0.28 | 0.28 | 16% |
| +individual | 0.19 | 0.18 | 0.22 | 0.32 | 0.33 | 20% |
| timestep | | | | | | |
| vectors | | | | | | |
| +curriculum | 0.21 | 0.17 | 0.26 | 0.35 | 0.37 | 35% |
| training | | | | | | |
| +interactive | 0.21 | 0.18 | 0.29 | 0.36 | 0.39 | — |
| inference | | | | | | |

The progressive curriculum training strategy, which transitions from simpler conditional generation to complex joint modeling tasks, further improved performance, particularly for intricate tracks like melody and instrument. Moreover, integrating an interactive Human-AI co-composition workflow yielded the highest mixing quality. This design allowed the model to alternate flexibly between generation modes and incorporate multiple human inputs as additional conditional signals. For example, the model could initially generate melody and instrument tracks, then leverage these as guidance to condition the subsequent generation of drums and bass, ensuring greater coherence across tracks.

It should be noted that the methods described herein describe possible implementations, and that the operations and the steps can be rearranged or otherwise modified and that other implementations are possible. Furthermore, aspects from two or more of the methods can be combined.

The description set forth herein, in connection with the appended drawings, describes example configurations and does not represent all the examples that can be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, can be practiced without these specific details. In some instances, well-known structures and devices are shown in block diagram form in order to avoid obscuring the concepts of the described examples.

The various illustrative blocks and modules described in connection with the disclosure herein can be implemented or performed with a general-purpose processor, a DSP, an ASIC, an FPGA, a Graphics Processing Unit (GPU) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices (e.g., a combination of a DSP and a microprocessor, multiple microprocessors, one or more microprocessors in conjunction with a DSP core, or any other such configuration).

The functions described herein can be implemented in hardware, software executed by a processor, firmware, or any combination thereof. If implemented in software executed by a processor, the functions can be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions can also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium can be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

The description herein is provided to enable a person skilled in the art to make or use the disclosure. Various modifications to the disclosure will be readily apparent to those skilled in the art, and the generic principles defined herein can be applied to other variations without departing from the scope of the disclosure. Thus, the disclosure is not limited to the examples and designs described herein but is to be accorded the broadest scope consistent with the principles and novel features disclosed herein.

What is claimed is:

1. A method for multi-track music generation, comprising:
receiving a text prompt describing desired musical attributes;
generating, using a diffusion model, multiple audio tracks based on the text prompt, wherein each audio track corresponds to a different musical component;
assigning individual timestep vectors respectively to each of the multiple audio tracks;
generating, using a diffusion model, one or more enhanced audio tracks based on the individual timestep vectors and corresponding audio track; and
combining the generated audio tracks to produce a multi-track musical composition.

2. The method of claim 1, further comprising receiving user feedback on the generated multi-track musical composition and regenerating one or more of the audio tracks based on the user feedback.

3. The method of claim 1, further comprising adding special prompt tokens to the text prompt to indicate specific generation tasks for each audio track.

4. The method of claim 1, further comprising training the diffusion model with a curriculum training strategy that progressively increases the complexity of multi-track generation tasks.

5. The method of claim 1, further comprising generating a visual representation of the multi-track musical composition to assist in the editing and refinement process.

6. The method of claim 1, further comprising incorporating user-provided audio tracks as conditioning signals to guide the generation of the multiple audio tracks.

7. The method of claim 1, wherein the different musical components comprise at least two of: bass, drums, instrument, and melody tracks.

8. The method of claim 7, further comprising:
receiving user feedback on one or more of the enhanced audio tracks; and
regenerating the one or more enhanced audio tracks based on the user feedback while maintaining consistency with other enhanced audio tracks.

9. The method of claim 8, wherein regenerating the one or more enhanced audio tracks comprises using a conditional distribution learned by the diffusion model to generate the one or more enhanced audio tracks conditioned on the other generated audio tracks.

10. The method of claim 1, wherein the text prompt includes genre-specific keywords to guide the generation of the multiple audio tracks.

11. The method of claim 1, wherein the diffusion model generates audio tracks that are temporally synchronized based on the individual timestep vectors.

12. The method of claim 1, wherein the generated audio tracks are evaluated for harmonic coherence before combining them into the multi-track musical composition.

13. A system configured for multi-track music generation, comprising:
a processor; and
memory operatively coupled with the processor and storing instructions which, when executed by the processor to cause the system to:
receive a text prompt describing desired musical attributes;
generate, using a diffusion model, multiple audio tracks based on the text prompt, wherein each audio track corresponds to a different musical component;
assign individual timestep vectors respectively to each of multiple audio tracks;
generate, using a diffusion model, one or more enhanced audio tracks based on the individual timestep vectors and corresponding audio track; and
combine the generated audio tracks to produce a multi-track musical composition.

14. The system of claim 13, wherein the instructions further cause the system to receive user feedback on the generated multi-track musical composition and regenerating one or more of the audio tracks based on the user feedback.

15. The system of claim 13, wherein the instructions further cause the system to receive special prompt tokens and add the special prompt tokens to the text prompt to indicate specific generation tasks for each audio track.

16. The system of claim 13, wherein the diffusion model is trained with a curriculum training strategy that progressively increases the complexity of multi-track generation tasks.

17. The system of claim 13, when the instructions further cause the system to generate a visual representation of the multi-track musical composition to assist in the editing and refinement process.

18. The system of claim 13, wherein user-provided audio tracks are incorporated as conditioning signals to guide the generation of the multiple audio tracks.

19. The system of claim 13, wherein the different musical components comprise at least two of: bass, drums, instrument, and melody tracks.

20. The system of claim 19, wherein the instructions further cause the system to:
receive user feedback on one or more of the enhanced audio tracks; and
regenerate the one or more enhanced audio tracks based on the user feedback while maintaining consistency with other enhanced audio tracks.

21. The system of claim 20, wherein regenerating the one or more enhanced audio tracks comprises using a conditional distribution learned by the diffusion model to generate the one or more enhanced audio tracks conditioned on the other generated audio tracks.

22. The system of claim 13, wherein the text prompt includes genre-specific keywords to guide the generation of the multiple audio tracks.

23. The system of claim 13, wherein the diffusion model generates audio tracks that are temporally synchronized based on the individual timestep vectors.

24. The system of claim 13, wherein the generated audio tracks are evaluated for harmonic coherence before combining them into the multi-track musical composition.
